(19) United States
(12) Patent Application Publication
(10) Pub. No.: US 2024/0109656 A1
(43) Pub. Date: Apr. 4, 2024

(54) Aerial Delivery Apparatus and Method of Constructing and Utilizing Same

(71) Applicant: Continental Automotive Systems, Inc., Auburn Hills, MI (US)

(72) Inventor: Alexander Stege, Rochester, MI (US)

(73) Assignee: Continental Automotive Systems, Inc., Auburn Hills, MI (US)

(21) Appl. No.: 17/936,872

(22) Filed: Sep. 30, 2022

(51) Int. Cl. B64C 39/02; B64C 9/10; B64C 13/28; B64D 17/02; G05D 1/00; G05D 1/10

(52) U.S. Cl. CPC B64C 39/024; B64C 9/10; B64C 13/28; B64D 17/02; G05D 1/0094; G05D 1/101; B64C 2201/108; B64C 2201/128

(57) ABSTRACT

A method and apparatus for aerial delivery of a package dropped from an elevated location. The apparatus includes a main body having an internal compartment for receiving a package to be delivered. A controllable component is detachably mounted along an exterior surface of the main body. A control unit is mounted within the main body for deploying and/or controlling the at least one controllable component during a descent of the aerial delivery apparatus. A portable power supply is mounted within the main body and connected to the control unit for powering same. The main body is dimensioned to receive the controllable component within the main body when detached therefrom and to serve as a return shipping container for return mail shipment following the descent of the aerial delivery apparatus.

### TECHNICAL FIELD

This disclosure relates to an apparatus for delivering an object to a planned delivery location, and particularly to such an apparatus that is reusable in multiple deliveries.

### BACKGROUND

It is known to use unmanned aerial vehicles (UAVs) to deliver packages. It is also known to drop a payload from an elevated position and maneuver the package so as to land at or near a planned target location. These approaches to delivering packages suffer from a considerable expense in transporting the package to the planned delivery location.

### SUMMARY

Example embodiments are directed to an aerial delivery apparatus, including a main body having an internal compartment for receiving an object to be delivered to a planned delivery location. At least one controllable component is detachably mounted along at least one exterior surface of the main body. A control unit is mounted within the main body for at least one of deploying or controlling the at least one controllable component during a descent of the aerial delivery apparatus towards the planned delivery location. The main body is dimensioned to receive the at least one controllable component within the main body when the at least one controllable component is detached therefrom and to serve as a return shipping container for return mail shipment following a completion of the descent of the aerial delivery apparatus.

The at least one controllable component is operatively connected to the at least one exterior surface of the main body during the descent of the aerial delivery apparatus, and is manually detachable from the main body.

In one implementation, the at least one controllable component includes a parachute having a canopy and a plurality of cords connecting the canopy to the at least one exterior surface of the main body. The cords are detachable from the main body for storage of the parachute in the main body following the completion of the descent and the delivery of the aerial delivery apparatus.

The aerial delivery apparatus may include one or more actuators having at least one input connected to at least one output of the control unit. The one or more actuators are controlled by the control unit to vary a tension of at least one of the plurality of cords so as to steer the main body to the planned landing destination.

In another implementation, the at least one controllable component includes a propeller. The aerial delivery apparatus further includes a motor having at least one input coupled to at least one output of the control unit. The control unit controls rotation of the propeller via the motor. The propeller is rotatably connected to the main body via a fastening mechanism. The fastening mechanism is manually manipulated for detaching the propeller from the main body.

In another implementation, the at least one controllable component includes a flap pivotally coupled to the at least one exterior surface of the main body via at least one hinge. The aerial delivery apparatus further includes a servo having at least one input coupled to an output of the control unit. The servo is mechanically coupled to the flap via a linkage. The control unit controls movement of the flap via the servo. The hinge is manually manipulatable for detaching the flap from the main body.

In another implementation, the at least one controllable component is connected to the main body via at least one pin or at least one screw. The at least one pin or the at least one screw pin is manually removable to detach the at least one component from the main body.

In another implementation, the at least one controllable component includes at least one tank of a compressed fluid and at least one fluid outlet in fluid communication with the at least one tank and disposed along an external surface of the main body. The aerial delivery apparatus includes at least one fluid outlet valve through which the compressed fluid is discharged from the at least one tank. The at least one fluid outlet valve is selectively opened and closed by at least one output of the control unit.

The at least one tank includes a single tank, the plurality of fluid outlets include a plurality of fluid outlets in fluid communication with the single tank, the at least one fluid outlet valve includes a plurality of fluid outlet valves. Each fluid outlet valve is coupled between the single tank and a distinct fluid outlet, and each fluid outlet valve is independently opened and closed by the control unit.

The at least one fluid outlet valve includes four fluid outlet valves, each at least one fluid outlet includes four fluid outlets, and each tank is associated with a single fluid outlet valve and connected to a distinct fluid outlet.

The control unit may include a GPS unit which determines a location of the aerial delivery apparatus. The control unit controls the at least one controllable component based upon the location of the aerial delivery apparatus and a location of the planned delivery location.

Another example embodiment is directed to a method for delivering an item to a planned delivery location. The method includes providing an aerial delivery apparatus containing an item to be delivered, the aerial delivery apparatus including a main body, a control unit disposed within the main body, one or more sensors communicatively coupled to the control unit, and at least one controllable component mounted along an exterior surface of the main body. The method includes receiving and storing a planned delivery location in memory of the control unit. At least one of the control unit and the one or more sensors detects the aerial delivery apparatus descending from an elevated position. The control unit determines a location of the aerial delivery apparatus and a location of the planned delivery location. One or more sensors senses one or more characteristics corresponding to the descent of the aerial delivery apparatus. The control unit performs at least one of deploying or controlling the at least one controllable component based upon at least one of the location of the aerial delivery apparatus, the location of the planned delivery location, or the one or more characteristics corresponding to the descent of the aerial delivery apparatus, the least one controllable component changing the descent of the aerial delivery apparatus. The at least one controllable component is manually detachable from the main body by a recipient of the item. The main body is sized and dimensioned for receiving the at least one controllable component when detached from the main body. The main body serves as a mail return shipping container for reuse in subsequent deliveries

In at least one implementation, the at least one controllable component includes a parachute that is deployed by the control unit and controlled for steering the aerial delivery apparatus towards the planned delivery location. The parachute includes a canopy and cords connected between the canopy and the main body, and the cords are manually detachable from the main body.

In at least one implementation, the at least one controllable component includes at least one container of compressed fluid disposed in the main body. At least one fluid outlet is in fluid communication with the at least one container. At least one fluid outlet valve is in fluid communication between the at least one container and the at least one fluid outlet. Each fluid outlet valve is controlled by the control unit. The at least one fluid outlet is detachably mounted to one or more exterior surfaces of the main body.

In at least one implementation, the at least one controllable component includes at least one propeller and support hardware for supporting the at least one propeller. The at least one propeller and the support hardware are detachable from the main body for storage therein following the descent of the aerial delivery apparatus.

In at least one implementation, the at least one controllable component includes at least one flap pivotably mounted to an exterior surface of the main body via at least one hinge. In this implementation, the aerial delivery apparatus further includes an actuator controlled by the control unit and a linkage mechanically coupled between the actuator and the at least one flap. The at least one flap is detachable from the exterior surface.

### DESCRIPTION OF DRAWINGS

FIG. 1 is a perspective view of an aerial delivery apparatus configured for mail shipment according to an example embodiment.

FIG. 2 is a perspective view of the aerial delivery apparatus of FIG. 1 with a lid in its open position.

FIG. 3 is a block diagram schematic of a portion of the aerial delivery apparatus of FIG. 1.

FIGS. 4 and 5 are perspective views of configurations of the aerial delivery apparatus according to an example embodiment.

FIGS. 6A and 6B are internal views of the aerial delivery apparatus of FIGS. 4 and 5 according to two example embodiments.

FIGS. 7 and 8 are top and side views, respectively, of an aerial delivery apparatus according to another example embodiment.

FIGS. 9 and 10 are side and top views, respectively, of an aerial delivery apparatus according to another example embodiment.

FIGS. 11 and 12 are perspective and end views, respectively, of an aerial delivery apparatus according to another example embodiment.

FIG. 13 is a flowchart describing an operation of the aerial delivery apparatus according to an example embodiment.

Like reference symbols in the various drawings indicate like elements.

### DETAILED DESCRIPTION

Example embodiments of the present disclosure are directed to an aerial delivery apparatus which is adapted to descend from an elevated position to a planned delivery location. The aerial delivery apparatus may be dropped from an airplane, UAV, rocket or other aerial vehicle. In the alternative, the aerial delivery apparatus may be propelled into the air to the elevated position by other mechanisms, such as a catapult or cannon. From the elevated position, the aerial delivery apparatus autonomously or semi-autonomously controls its descent towards the planned delivery location. The aerial delivery apparatus is configured to contain an object that is intended for delivery at the planned delivery location. The aerial delivery apparatus is configurable such that upon completion of the descent at or near the planned delivery location, the object is easily removed from the aerial delivery apparatus and the aerial delivery apparatus is easily configured for return mail shipment via a traditional mail delivery carrier. In this way, the aerial delivery apparatus may be reused for subsequent deliveries of other objects to other planned delivery locations, thereby saving considerable cost in delivering objects.

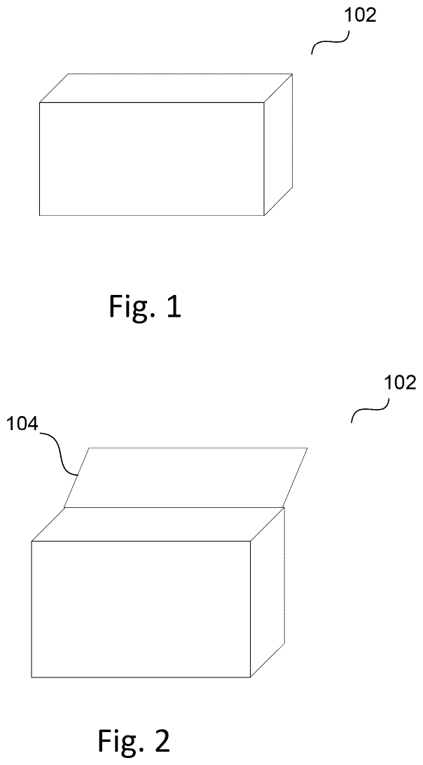

FIGS. 1 and 2 illustrate an aerial delivery apparatus 10 according to an example embodiment. The aerial delivery apparatus 10 includes a main body 102. The aerial delivery apparatus 10 is configured in FIGS. 1 and 2 as a shipping container for shipment via a mail delivery service. The main body 102 is illustrated as having the shape of a rectangular prism but it is understood that main body 102 may have other shapes, such as a cylindrical shape or a square prism shape. The main body 102 is constructed from a lightweight and at least partly rigid composition, such as a rigid cardboard or a plastic composition. The main body 102 may be sized to hold in its interior at least one object to be delivered. The aerial delivery apparatus 10 may have any of a number of different sizes for holding objects of varying sizes. The main body 102 includes a lid 104 having an edge that is connected to an edge of the reset of the main body 102 such that the lid 104 is moveable between a closed position as shown in FIG. 1 and an open position as shown in FIG. 2 for placing one or more objects therein for a planned delivery.

As mentioned, the aerial delivery apparatus 10 is configured for autonomous or semi-autonomous maneuvering as the aerial delivery apparatus 10 descends from an elevated position above a planned delivery location. It is understood that the particular elevated position may depend upon a number of factors, such as, but not limited to, the terrain surrounding the planned delivery location; structures, natural or man-made, near the planned delivery location; and weather conditions including wind, rain, fog and snow.

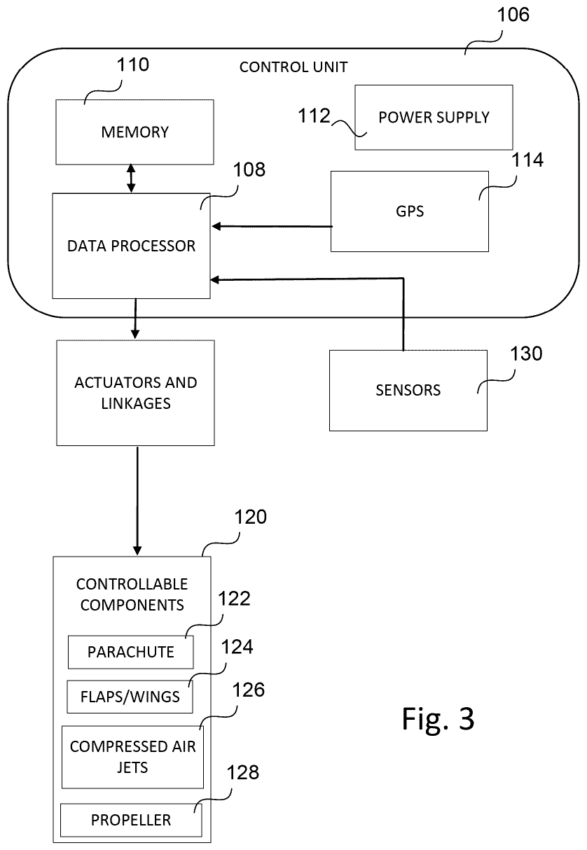

FIG. 3 depicts portions of the aerial delivery apparatus 10 according to an example embodiment. The aerial delivery apparatus 10 includes a control unit 106 which autonomously or semi-autonomously controls the aerial delivery apparatus 10 during its descent to the planned delivery location. The control unit 10 includes data processing hardware 108 and non-transitory memory 110, such as volatile and/or non-volatile memories, having stored therein program code instructions which, when executed by the data processing hardware 108 causes the data processing hardware to perform functions to control the maneuvering of the aerial delivery apparatus 10 as it descends towards the planned delivery location. A portable power supply 112 is electrically connected and provides power to the components of the control unit 106.

In at least one example embodiment, the control unit 106 determines positional information of the aerial delivery apparatus 10 during the descent of the aerial delivery apparatus 10. This may include a global positioning satellite (GPS) unit 114 or other module capable of triangulating the position of the aerial delivery apparatus 10. The GPS unit 114 may include processors and antennae. The particular contents of GPS units are well known in the art such that a description thereof will not be described in detail. In addition or in the alternative, the aerial delivery apparatus 10 may include one or more sensors 130, such as a camera, Lidar and/or radar, for use in detecting objects in the environment of the aerial delivery apparatus 10 and particularly in the path of the aerial delivery apparatus 10 during its descent to the planned delivery location. In detecting objects, the control unit 106 may classify the detected objects and determine whether maneuvering of the aerial delivery apparatus 10 is needed based upon the classification or type of objected detected. The one or more sensors 130 also provides elevation information for the aerial delivery apparatus 10 for use in controlling the descent of the aerial delivery apparatus 10.

With continued reference to FIG. 3, the aerial delivery apparatus 10 further includes one or more controllable components 120 which are controlled by the control unit 106 for maneuvering the aerial delivery apparatus 10 towards the planned delivery location during its descent. The controllable components 120 may include, for example, a parachute assembly 122; one or more flaps or wings 124; compressed air jet assemblies 126; and/or at least one propeller 128. It is understood that the controllable components 120 may include other components that are controlled by the control unit 106 for maneuvering the aerial delivery apparatus 10 during its descent towards the planned delivery target. At least some of the controllable components 120 are controlled by the control unit 106 using actuators and/or linkages, as discussed in greater detail below.

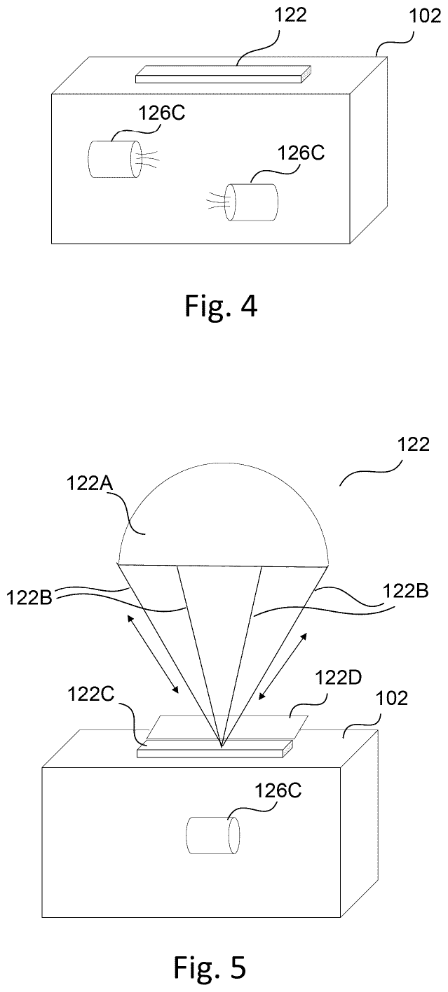

The parachute assembly 122 may include one or more parachutes connected to the main body 102. Specifically, each parachute is deployable by the control unit 106 to at least slow the descent of the aerial delivery apparatus 10. FIG. 4 illustrates the parachute assembly 122 in its pre-deployment state, and FIG. 5 illustrates the parachute assembly 122 in its deployed state. The parachute assembly 122 is disposed along an exterior surface of the main body 102, such as its top exterior surface. The parachute assembly 122 includes a canopy 122A; a plurality of cords 122B connected between the canopy 122A and the main body 102; and an enclosure 122C with a lid 122D which separates from the enclosure 122C responsive to activation by the control unit 106, thereby allowing the canopy 122A and cords 122B to be discharged from the enclosure 122C during parachute deployment.

In an example embodiment, the parachute assembly 122 further includes a steerable control feature. Specifically, the parachute assembly 122 may include a tensioning mechanism which selectively tensions cords 122B to effectuate steering of the parachute. With location information of the aerial delivery apparatus 10 and location information of the planned delivery location, the control unit 106 determines the cord(s) 122B which is to be tensioned relative to the other cords 122B so that the aerial delivery apparatus 10 is maneuvered towards the planned delivery location. The tensioning is illustrated by the arrows shown in FIG. 5. The control unit 106 also determines whether there exists an obstruction in the path between the location of the aerial delivery apparatus 10 and the location of the planned delivery location, such as a tree. Control unit 106 adjusts the cord tensioning so as to avoid collision with the obstruction. The cord tensioning mechanism for cords 122B, which may include spools around which cords 122B are selectively wound, may be located in the enclosure 122C and/or the main body 102.

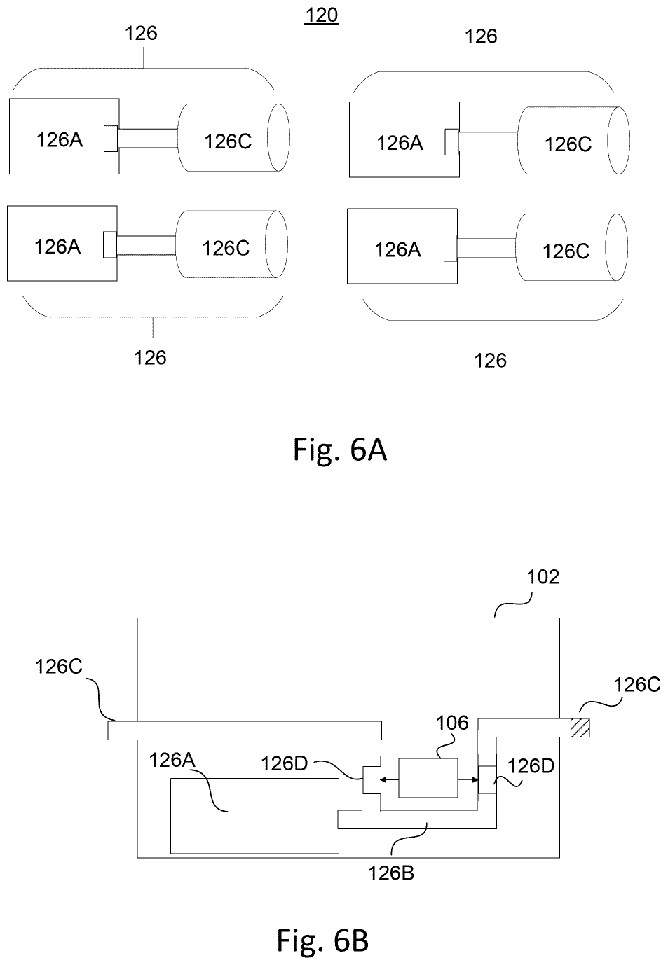

According to at least one example embodiment, the controllable component 120 may include a plurality of compressed air jet assemblies 126. In this embodiment, each compressed air jet assembly 126 provides at least one burst of air so that the aerial delivery apparatus 10 may be propelled to move in a distinct horizontal direction. FIG. 6A shows four compressed air jet assemblies 126 for moving the aerial delivery apparatus 10 in up to four horizontal directions. As shown, each compressed air jet assembly 126 includes a tank 126A of compressed air or other fluid; a fluid outlet 126C which is mounted along a vertical surface of the main body 102 (see FIGS. 4 and 5); and tubing connecting an outlet of the tank 126A to the fluid outlet 126C. In this embodiment, the outlet of each tank is an outlet valve which is selectively closed or opened by the control unit 106. Each compressed air jet assembly 126 is separately actuated by the control unit 106 opening the outlet valve of the tank 126A, which causes air to discharge from the fluid outlet 126C so that the aerial delivery apparatus 10 is caused to translate in the horizontal direction as determined by the positioning of the fluid outlet 126C. Each compressed air jet assembly 126 may be actuated a limited number of times, which may be one time or more than one time. By arranging the fluid outlets 126C so that each outlet faces a different horizontal direction, as partly indicated in FIG. 4 with two fluid outlets 126C facing opposite directions along a surface of the main body 102, the aerial delivery apparatus 10 may be horizontally moved in any direction by actuating one or more compressed air jet assemblies 126, thereby resulting in the aerial delivery apparatus 10 being translated toward the planned target location and/or to avoid an obstruction.

According to another example embodiment, a single compressed air jet assembly 126 forms the controllable component 120 for maneuvering the aerial delivery apparatus 10 towards the planned delivery location and/or around an obstruction. Specifically, the compressed air assembly 126 may provide, for example, a limited number of bursts of air (or some other fluid) in one or more directions so that the aerial delivery apparatus 10 is translated horizontally. For example, the limited number of bursts may be one air burst. Referring to FIG. 6B, the compressed air assembly 126 may include a single tank 126A of compressed air or other fluid; tubing 126B disposed between an outlet of the tank 126A and one or more fluid outlets 126C of the compressed air assembly 126; and fluid outlet valves 126D, each of which is disposed between the outlet of the tank 126A and a distinct fluid outlet 126C. The fluid outlet valves 126C may be seen as part of the actuators depicted in FIG. 3. Two fluid outlets 126C are shown in FIG. 4 as being arranged along the same exterior surface of the main body 102 and facing different directions so that the aerial delivery apparatus 10 may be translated in opposite lateral (in this case, horizontal) directions. FIG. 6 illustrates two fluid outlets 126C arranged along opposite exterior surfaces of the main body 102, and facing in opposite directions. It is understood, however, that more or less than two fluid outlets 126 C may be used. In one implementation, four fluid outlets 126C may be arranged along each vertical exterior surface of the main body so as to provide translation of the aerial delivery apparatus 10 in any of four lateral (horizontal) directions. The fluid outlet valves 126D are individually controlled by the control unit 106 to be switched between the open and closed states. Opening a single fluid outlet valve 126D allows for discharge of compressed air and a propulsion of the aerial delivery apparatus 10 in a direction of the fluid outlet 126C corresponding to the opened fluid outlet valve 126D.

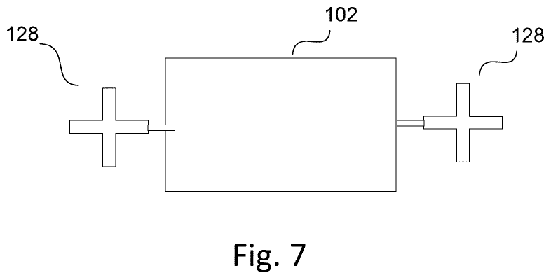

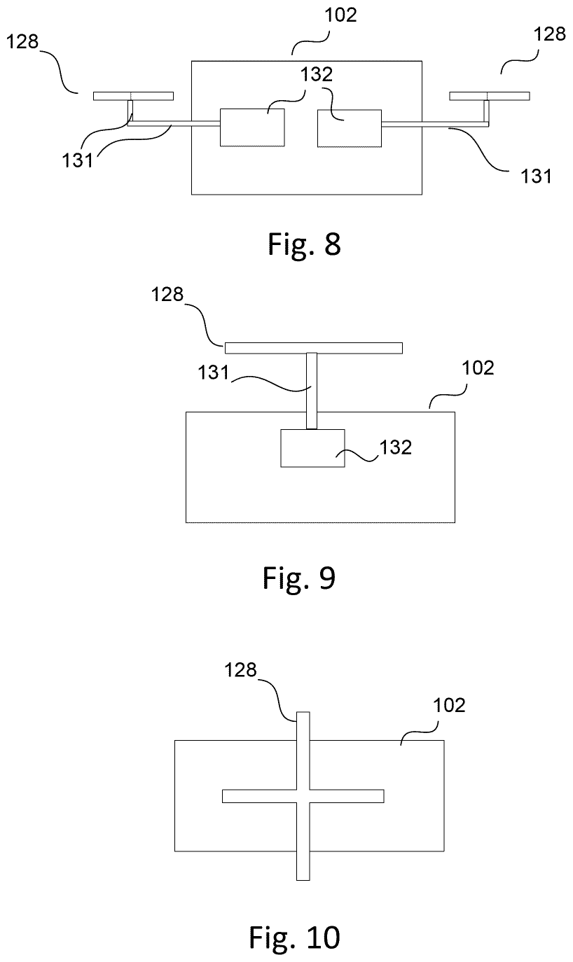

In at least one example embodiment, the controllable components 120 include one or more propellers 128 which extend from one or more exterior surfaces of the main body 102. FIGS. 7 and 8 are top and side views, respectively, of the aerial delivery apparatus 10 having two propellers 128 extending from opposed exterior surfaces of the main body 102. FIGS. 9 and 10 are side and top views, respectively, of the aerial delivery apparatus 10 having a single propeller 128 extending from a top exterior surface of the main body 102. In the single propeller embodiment of FIGS. 9 and 10, the propeller 128 is powered by a motor 132 which is controlled by the control unit 106. In the dual propeller embodiment of FIGS. 7 and 8, each propeller 128 is controlled by its own motor 132, with motors 132 being controlled by the control unit 106. The motors 132 in the embodiments may be seen as actuators depicted in FIG. 3. The aerial delivery apparatus may include a sensor 130, such as an accelerometer, which detects the velocity or acceleration of the aerial delivery apparatus 10, and the control unit 106 runs the motor 132 to cause the propellers 128 to rotate if the detected velocity or acceleration exceeds a predetermined threshold value. The amount of rotation of the shaft of the motor 132 may be based upon a differential between the detected velocity or acceleration and the predetermined threshold value. By activating the motor 132 to rotate the propeller(s) 128, the descent of the aerial delivery apparatus 10 is slowed so as to limit the amount of impact on the aerial delivery apparatus 10 on the ground, thereby lessening damage to the aerial delivery apparatus 10 and/or the object(s) disposed therewithin.

In another aspect, the propellers 128 are not controlled by the control unit 106 via the motor 132. Instead, the propellers 128 are configured to rotate by action of air moving upwardly through the propeller during the descent of the aerial delivery apparatus towards the planned delivery location.

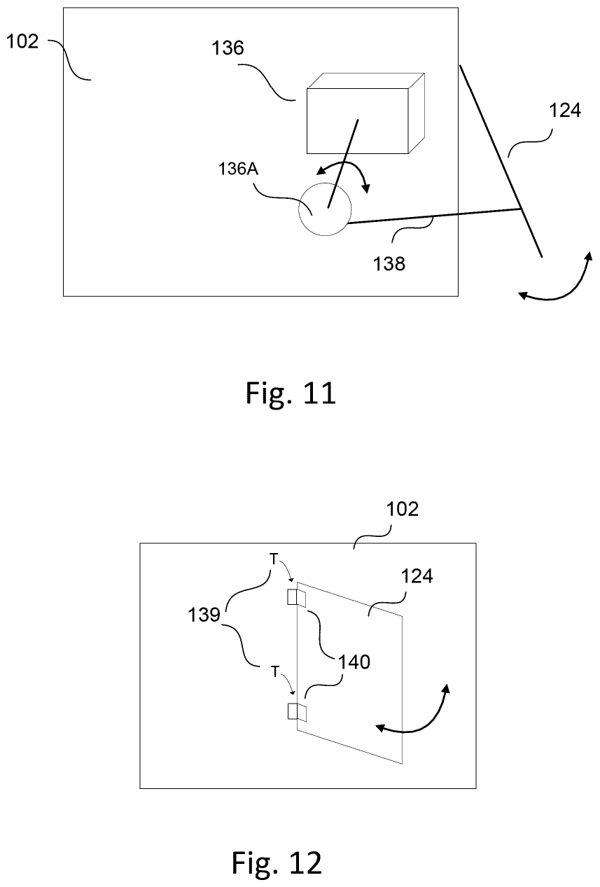

In at least one example embodiment, the controllable components 120 include a control surface, such as a flap or wing, which is pivotably connected to at least one exterior surface of the main body 102. FIGS. 11 and 12 illustrate a flap 124 disposed from a side exterior surface of the main body 102 of the aerial delivery apparatus 10. Flaps 124 are pivotably and/or rotatably mounted to the main body 102 and in particular are mounted to a side (vertical) exterior surface of the main body 102. FIG. 11 illustrates a flap 124 which is pivotably mounted to the main body 102 along a horizontal pivot axis to, for example, slow the descent of the aerial delivery apparatus 10 when deployed; and FIG. 12 illustrates the flap 124 which is pivotably mounted to the main body 102 along a vertical pivot axis to facilitate maneuvering of the aerial delivery apparatus 10 when deployed. In each case, the flap 124 is rotated along its rotation axis under control of the control unit 106 using a servo 136 and linkage 138 as shown in FIG. 11. The linkage 138 may be seen as a linkage depicted in FIG. 3, and the servo 136 may be seen as an actuator depicted in FIG. 3. The linkage 138 is connected to the control horn 136A of the servo 136 at one longitudinal end and to the flap 124 at an opposed longitudinal end. The control unit 106 is communicatively coupled to the servo 136 and controls movement of the control horn 136A of the servo 136 which causes the linkage 138 and the flap 124 to rotate or pivot in response. It is understood that a motor may be used in place of the servo 136. It is also understood that the aerial delivery apparatus 10 may include a plurality of flaps 124, with each flap 124 being coupled to its own servo 136 or at least some of the flaps 124 being coupled to the same servo 136 such that a single servo 136 controls more than one flap 124.

It is further understood that the aerial delivery apparatus 10 may include any one or more of the controllable components 120 in any combination.

According to example embodiments, the controllable components 120 are configured to be detachably mounted to an outer exterior surface of the main body 102. This detachability feature allows for the controllable components 120 to be stored in the main body 102 following the delivery of the aerial delivery apparatus 10 at the completion of its descent, so that the aerial delivery apparatus 10 is suitable for mail shipment to the supplier which delivered the aerial delivery apparatus 10 (containing the object) to the planned delivery location.

For instance, the parachute 122A, 122B of the parachute assembly 122 (FIGS. 4 and 5) may be disconnected from the main body 102 after its deployment. In one implementation, the ends of the cords 122B may connect to the main body 102 using hooks, such as clevis hooks, carabiners, ring shackles, screws, etc. These detachment mechanisms may allow for the parachute to be manually disconnected or detached from the main body 102 for subsequent storage therein.

Fluid outlets 126C (FIGS. 4-6) may be connected along the exterior surface of the main body 102 using a mount that attaches to the main body 102 by nuts and bolts, screws, etc. This detachment mechanisms may allow for the fluid outlets 126C to be easily detached from the main body 102 for subsequent placement within the main body 102.

Propellers 130 and their corresponding supporting hardware 131 (FIGS. 7-10) may be disassembled by manually disconnecting the hardware from the motor 132 and from the main body 102, and disconnecting the propellers 130 from their supporting hardware 131 so that the hardware and the propellers 130 may be stowed within the main body 102 for return shipment.

Referring again to FIGS. 11 and 12, the linkage 138 may be manually disconnected from the control horn 136A of the servo and from the flap 124. In addition, if the flaps are connected to the main body 102 using one or more hinges 140, the flaps may be detached from the main body 102 by manually removing the hinge pins 139.

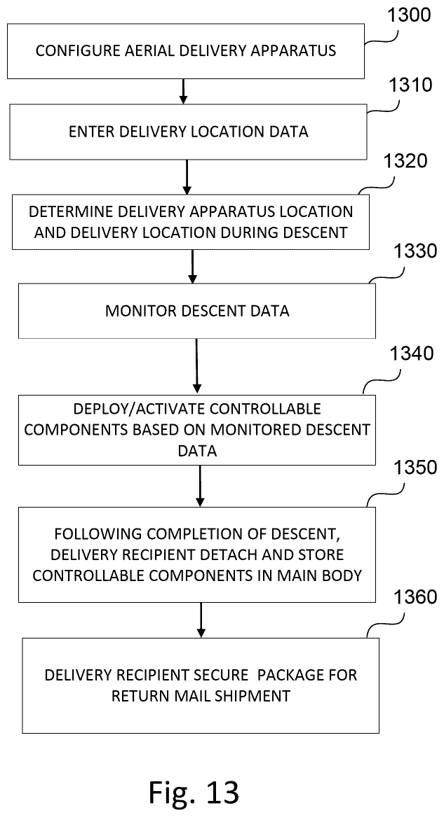

A method of delivering an object to a planned delivery location will be described with respect to FIG. 13. Initially, a customer may purchase an item online and select aerial delivery in order to receive the purchased item on the same day. The selection of the aerial delivery may include payment of a deposit which may correspond to a replacement cost of the aerial delivery apparatus 10. Following the purchase and the selection of aerial delivery, the supplier prepares for the delivery by, among other things, optionally configuring the aerial delivery apparatus 10 for the planned delivery at 1300 based in part upon characteristics of the object to be delivered, such as the object's size and weight, the terrain and the weather. This may involve adding the controllable components which may best provide for a successful delivery. Next, the delivery location data is entered into the control unit 106 at 1310. The purchased item to be delivered is stored in the main body 102 and the aerial delivery apparatus 10 is transported (by plane, drone, catapult, etc.) to an elevated position relative to the planned delivery location. In one scenario, a UAV drops or otherwise releases the aerial delivery apparatus 10 from the elevated position. The aerial delivery apparatus 10 may detect its initial descent using sensors 130 such as an accelerometer. Throughout the descent of the aerial delivery apparatus 10, the control unit 106 determines at 1320 its location and the location of the planned delivery location. This may be at least partly performed by the GPS unit 114. The control unit 106 may utilize sensor data from sensors 130 in determining the location of the planned delivery location as well as the current elevation of the aerial delivery apparatus 10. Also throughout the descent of the aerial delivery apparatus 10, the control unit 106 may monitor characteristics of the descent at 1330, such as velocity and/or acceleration of the aerial delivery apparatus 10. In response to the recently determined location of the aerial delivery apparatus 10, the recently determined location of the planned delivery location, and/or the recently determined descent characteristics, the control unit 106 may deploy and/or activate one or more controllable components 120 at 1340. This action may be to slow the descent and/or to maneuver the aerial delivery apparatus 10 towards the planned delivery location. Actions may include deploying the parachute; opening a fluid outlet valve 126D to generate an air burst from a fluid outlet 126C of the compressed air assembly 126 which causes the aerial delivery apparatus 10 to move in a lateral (horizontal) direction towards the planned delivery location; activating the propeller(s) 130 to slow the descent; and/or moving a control surface or flap 124. The action may also be to avoid any objects determined to be in the path of the aerial delivery apparatus 10 during its descent.

Following the aerial delivery apparatus 10 completing its descent and landing at or near the planned delivery location, the delivered object may be removed from the main body 102; the controllable components 120 of the aerial delivery apparatus 10 may be detached at 1350 from the main body 120 as described above and placed in the main body 102, which serves as the return shipping container; and the aerial delivery apparatus in its entirety may be shipped at 1360 via return mail to the supplier which delivered the purchased item. Upon receipt of the aerial delivery apparatus 10 at the supplier, the supplier may replace or refill the compressed air tank as needed, and configure the aerial delivery apparatus 10 for another delivery.

Various implementations of the systems and techniques described here relating to the control unit 106 can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

By using lightweight components, excluding from the aerial delivery apparatus 10 components for placing the apparatus at an elevated position, and reusing the aerial delivery apparatus 10 for subsequent deliveries result in the cost for the aerial delivery apparatus 10 being markedly reduced.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims.

What is claimed is:

1. An aerial delivery apparatus, comprising:
a main body comprising an internal compartment for receiving an object to be delivered to a planned delivery location;
at least one controllable component detachably mounted along at least one exterior surface of the main body;
a control unit mounted within the main body for at least one of deploying or controlling the at least one controllable component during a descent of the aerial delivery apparatus towards the planned delivery location; and
a portable power supply mounted within the main body and connected to the control unit for powering same;
wherein the main body is dimensioned to receive the at least one controllable component within the main body when the at least one controllable component is detached therefrom and to serve as a return shipping container for return mail shipment following a completion of the descent of the aerial delivery apparatus.

2. The aerial delivery apparatus of claim 1, wherein the at least one controllable component is operatively connected to the at least one exterior surface of the main body during the descent of the aerial delivery apparatus, and is manually detachable from the main body.

3. The aerial delivery apparatus of claim 2, wherein the at least one controllable component comprises a parachute having a canopy and a plurality of cords connecting the canopy to the at least one exterior surface of the main body, and the cords are detachable from the main body for storage of the parachute in the main body following the completion of the descent and the delivery of the aerial delivery apparatus.

4. The aerial delivery apparatus of claim 3, further comprising one or more actuators having at least one input connected to at least one output of the control unit, the one or more actuators being controlled by the control unit to vary a tension of at least one of the plurality of cords so as to steer the main body to the planned landing destination.

5. The aerial delivery apparatus of claim 2, wherein the at least one controllable component comprises a propeller, the aerial delivery apparatus further comprises a motor having at least one input coupled to at least one output of the control unit, the control unit controls rotation of the propeller via the motor, the propeller is rotatably connected to the main body via a fastening mechanism, and the fastening mechanism is manually manipulated for detaching the propeller from the main body.

6. The aerial delivery apparatus of claim 2, wherein the at least one controllable component comprises a flap pivotally coupled to the at least one exterior surface of the main body via at least one hinge, the aerial delivery apparatus further comprises a servo having at least one input coupled to an output of the control unit, the servo being mechanically coupled to the flap via a linkage, the control unit controls movement of the flap via the servo, and the hinge is manually manipulatable for detaching the flap from the main body.

7. The aerial delivery apparatus of claim 2, wherein the at least one controllable component is connected to the main body via at least one pin or at least one screw, the at least one pin or the at least one screw pin being manually removable to detach the at least one component from the main body.

8. The aerial delivery apparatus of claim 2, wherein the at least one controllable component comprises at least one tank of a compressed fluid and at least one fluid outlet in fluid communication with the at least one tank and disposed along an external surface of the main body, and the aerial delivery apparatus comprises at least one fluid outlet valve through which the compressed fluid is discharged from the at least one tank, the at least one fluid outlet valve is selectively opened and closed by at least one output of the control unit.

9. The aerial delivery apparatus of claim 8, wherein the at least one tank comprises a single tank, the plurality of fluid outlets comprising a plurality of fluid outlets in fluid communication with the single tank, the at least one fluid outlet valve comprises a plurality of fluid outlet valves, each fluid outlet valve is coupled between the single tank and a distinct fluid outlet, and each fluid outlet valve is independently opened and closed by the control unit.

10. The aerial delivery apparatus of claim 8, wherein the at least one fluid outlet valve comprises four fluid outlet valves, each at least one fluid outlet comprises four fluid outlets, and each tank is associated with a single fluid outlet valve and connected to a distinct fluid outlet.

11. The aerial delivery apparatus of claim 1, wherein the control unit includes a GPS unit which determines a location of the aerial delivery apparatus, and the control unit controls the at least one controllable component based upon the location of the aerial delivery apparatus and a location of the planned delivery location.

12. A method of delivering an item, comprising:
providing an aerial delivery apparatus containing an item to be delivered, the aerial delivery apparatus including a main body, a control unit disposed within the main body, one or more sensors communicatively coupled to the control unit, and at least one controllable component mounted along an exterior surface of the main body;
receiving and storing a planned delivery location in memory of the control unit;
detecting, by at least one of the control unit and the one or more sensors, the aerial delivery apparatus descending from an elevated position;
determining, by the control unit, a location of the aerial delivery apparatus and a location of the planned delivery location;
sensing, by the one or more sensors, one or more characteristics corresponding to the descent of the aerial delivery apparatus;
at least one of deploying or controlling, by the control unit, the at least one controllable component based upon at least one of the location of the aerial delivery apparatus, the location of the planned delivery location, or the one or more characteristics corresponding to the descent of the aerial delivery apparatus, the least one controllable component changing the descent of the aerial delivery apparatus,
wherein the at least one controllable component is manually detachable from the main body by a recipient of the item, the main body is sized and dimensioned for receiving the at least one controllable component when detached from the main body, and the main body serves as a mail return shipping container for reuse in subsequent deliveries.

13. The method of claim 12, wherein the at least one controllable component comprises a parachute that is deployed by the control unit and controlled for steering the aerial delivery apparatus towards the planned delivery location, the parachute including a canopy and cords connected between the canopy and the main body, the cords being manually detachable from the main body.

14. The method of claim 12, wherein the at least one controllable component comprises at least one container of compressed fluid disposed in the main body, at least one fluid outlet in fluid communication with the at least one container, and at least one fluid outlet valve in fluid communication between the at least one container and the at least one fluid outlet, each fluid outlet valve is controlled by the control unit, and the at least one fluid outlet is detachably mounted to one or more exterior surfaces of the main body.

15. The method of claim 11, wherein the at least one controllable component comprises at least one propeller and support hardware for supporting the at least one propeller, the at least one propeller and the support hardware being detachable from the main body for storage therein following the descent of the aerial delivery apparatus.

16. The method of claim 11, wherein the at least one controllable component comprises at least one flap pivotably mounted to an exterior surface of the main body via at least one hinge, the aerial delivery apparatus further comprises an actuator controlled by the control unit and a linkage mechanically coupled between the actuator and the at least one flap, the at least one flap being detachable from the exterior surface.
